(19) United States
(12) Patent Application Publication
(10) Pub. No.: US 2014/0327910 A1
(43) Pub. Date: Nov. 6, 2014

(54) FIBER TRANSPARENCY TESTING METHOD AND APPARATUS

(71) Applicants: Yanming Shen, Shanghai (CN); Hongyan Xu, Shanghai (CN); Haohua Li, Shanghai (CN)

(72) Inventors: Yanming Shen, Shanghai (CN); Hongyan Xu, Shanghai (CN); Haohua Li, Shanghai (CN)

(73) Assignee: Honeywell International Inc., Morristown, NJ (US)

(21) Appl. No.: 14/111,214

(22) PCT Filed: Dec. 22, 2011
(86) PCT No.: PCT/CN2011/002162

§ 371 Date: Jul. 22, 2014

(51) Int. Cl. G01N 21/59; G01N 21/01

(52) U.S. Cl. CPC G01N 21/59; G01N 21/01; G01N 2201/04
USPC 356/432; 356/244

(57) ABSTRACT

Polymeric fibers may be tested for optical properties; such as transparency in a manner that provides reproducible test results. A holder be used that is configured to hold polymeric fibers in a stacked, single file manner in which the polymeric fibers are held closely together. The fibers may be tested using an optical apparatus employing an integrating sphere.

### FIELD OF THE INVENTION

The invention relates generally to testing methods and more particularly to methods of testing polymeric fibers for transparency.

### BACKGROUND

Polymeric fibers are used in a wide range of applications. In many cases, the optical properties (e.g., color, reflectance, transmission) of the polymeric fibers are important to a particular commercial application. For example, the transparency of polyamide fibers is important for use in e.g., fish nets and fishing line. While the relative transparency of a polymeric fiber may be judged visually, there is a desire to be able to quantitatively and reproducibly test the transparency of polymeric fibers. One of the difficulties in testing the optical properties such as transparency of polymeric fibers in a spectrophotometer or similar test apparatus is that the polymeric fibers themselves can be difficult to hold or align in a manner that permits reproducible testing.

### SUMMARY OF THE INVENTION

The invention is directed to methods of reproducibly testing optical properties of polymeric fibers as well as to an apparatus useful in the methods.

Accordingly, an embodiment of the invention is a method of measuring an optical property of polymeric fibers. A plurality of polymeric fibers are placed in a holder that is configured to align the plurality of polymeric fibers at least substantially parallel with each other and stacked atop each other in a single column. The holder is positioned relative to a light source and a light from the light source is passed through the aligned polymeric fibers. Light passing through the aligned polymeric fibers is detected in order to measure an optical property of the aligned polymeric fibers.

Another embodiment of the invention is a method of measuring the transparency of polymeric fibers. A plurality of polymeric fibers are arranged in an arrangement that permits reproducible transparency measurements. The aligned polymeric fibers are positioned relative to an integrating sphere having a light window, the holder positioned such that the aligned polymeric fibers cover the light window. Light passing through the aligned polymeric fibers is detected in order to measure light transmittance through the polymeric fibers

Another embodiment of the invention is a holder for testing optical properties of polymeric fibers. The tester includes a first frame member and a second frame member that is spaced apart from the first frame member to define a window between the first frame member and the second frame member. A channel extends through the holder and is configured to accommodate polymeric fibers extending across the opening. An enlarged opening extends through the holder and is in communication with the channel. A compression bar may be inserted into the enlarged opening and is configured to provide a compressive force on polymeric fibers disposed within the channel.

### BRIEF DESCRIPTION OF THE FIGURES

FIG. 1A is a schematic illustration of a holder in accordance with an embodiment of the present invention.

FIG. 1B is a schematic cross-section of a portion of the holder of FIG. 1B.

FIG. 2 is a schematic illustration of a test apparatus in accordance with an embodiment of the present invention.

FIG. 3 is a schematic illustration of a test apparatus in accordance with an embodiment of the present invention.

FIG. 4 is a flow diagram illustrating a method in accordance with an embodiment of the present invention.

FIG. 5 is a flow diagram illustrating a method in accordance with an embodiment of the present invention.

FIG. 6 is a graphical representation of test data.

FIG. 7 is a graphical representation of test data.

FIG. 8 is a graphical representation of test data.

### DETAILED DESCRIPTION

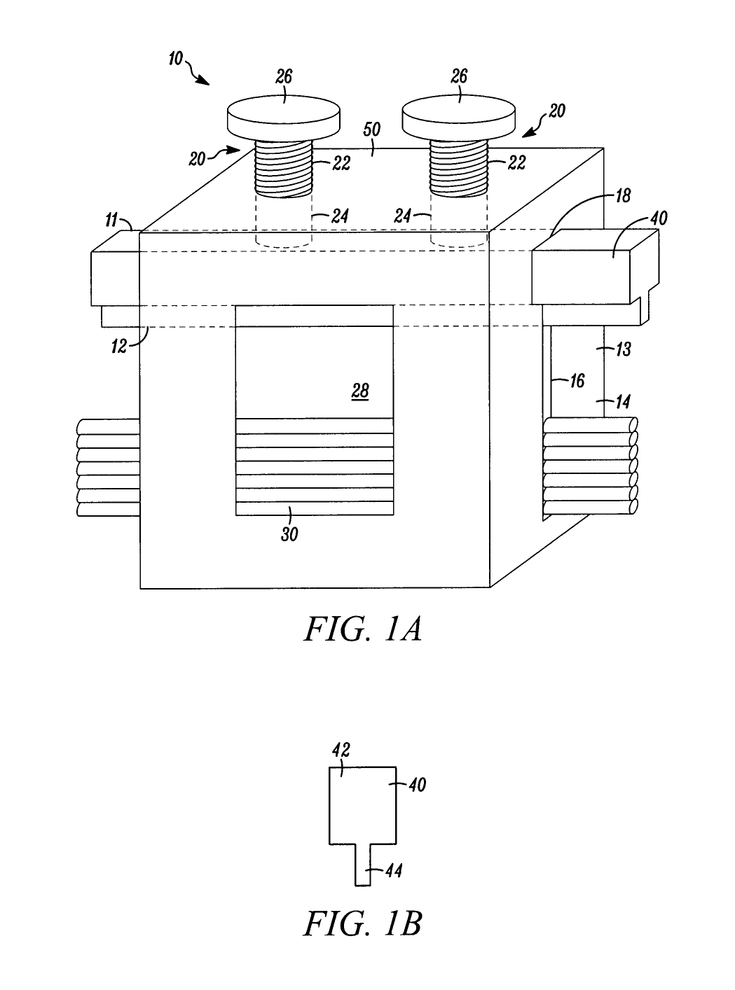

The present invention is directed to methods of testing polymeric fibers for optical properties such as transparency in a manner that provides reproducible test results. In some embodiments, the present invention is directed to a holder that is configured to hold polymeric fibers in a stacked, substantially parallel arrangement so that the polymeric fibers are held closely together. FIG. 1A is a schematic illustration of a holder 10.

In some embodiments, and as illustrated in FIG. 1A, the holder 10 includes a first frame member 12 and a second frame member 14. In some embodiments, the first frame member 12 and the second frame member 14 may be considered as first and second portions or regions of a single structure and may, for example, be molded or otherwise formed as a single structure. In some embodiments, the first frame member 12 and the second frame member 14 may be separately formed as distinct structures and may be combined in any desired fashion to form the holder 10. For example, if the first frame member 12 and the second frame member 14 are formed as distinct structures, they may be secured together using adhesives or mechanical fasteners such as screws, bolts or rivets. In some embodiments, the first frame member 12 and the second frame member 14 may be secured together in a way that permits adjustment in a relative spacing between the first frame member 12 and the second frame member 14.

In some embodiments, as illustrated, the holder 10 includes a channel 16 that extends through the holder 10. The channel 16 extends through the first frame member 12 and through the second frame member 14 such that the channel 16 extends from a left side 11 to a right side 13 of the holder 10. In some embodiments, the channel 16 may be cut or drilled into the holder 10. The channel 16 may be in communication with an enlarged opening 18 that is configured to permit a user to more easily place polymeric fibers into the housing 10. It will be appreciated that the enlarged opening 18 extends laterally through the holder 10, from the left side 11 to the right side 13 of the holder 10. Individual fibers 30 may be inserted laterally (in the illustrated orientation) through the enlarged opening 18 and then moved downward into the channels 16. The channels 16 may be configured to have a width that is a little larger than a diameter of the polymeric fibers that are intended for placement within the holder 10.

In some embodiments, the holder 10 may be configured to accommodate polymeric fibers having a range of about 0.1 millimeters to about 3 millimeters. In some embodiments, for example, the channels 16 may have a width that is about 0.01 millimeters to about 0.05 millimeters greater than a diameter of the polymeric fibers 30. In this manner, the polymeric fibers 30 are aligned to be substantially parallel and in a single file stacked arrangement even when a compression force is applied to the polymeric fibers 30 as further disclosed herein. Single file refers to the polymeric fibers 30 being arranged one atop each other such that the resulting stack is only one fiber wide.

In some embodiments, the polymeric fibers 30 are translucent, such that at least some light passes through the polymeric fibers 30. In some embodiments, the fibers may be considered as being at least substantially transparent, allowing a substantial fraction of incident light to pass through the polymeric fibers 30. In some instances, the polymeric fibers 30 may be polyamide fibers.

In some embodiments, the holder 10 may include a compression bar 40 that is configured to extend through the holder 10. FIG. 1B is a schematic cross-section of the compression bar 40, showing that in some embodiments, the compression bar 40 includes a first portion 42 that is configured to fit within the enlarged opening 18 and a second portion 44 that is configured to fit within the channel 16. In some embodiments, the compression bar 40 may be inserted into the holder 10 by aligning the first portion 42 with the enlarged opening 18 and aligning the second portion 44 with the channel 16. In some embodiments, the enlarged opening 18 may be configured to accommodate both the first portion 42 and the second portion 44 of the compression bar 40 such that the compression bar 40 may be inserted laterally through the enlarged opening 18 and then moved into position with the second portion 44 dropping into the channel 16. In some embodiments, the mass of the compression bar 40 itself may provide a sufficient compressive force on the polymeric fibers 30.

In some embodiments, the holder 10 may accommodate one or more compression members 20 that serve to provide a downward (in the illustrated orientation) compressive force onto the compression bar 40 in order to push adjacent polymeric fibers more closely together in order to reduce or eliminate air space between adjacent fibers, as air has different optical properties and can adversely affect test results. In some embodiments, inclusion of one or more compression members 20 permit use of the holder 10 in a variety of orientations.

In some embodiments, the holder 10 may include a third frame member 50 that spans between the first frame member 12 and the second frame member 14. In some embodiments, a first compression member 20 may be disposed within the third frame member 50 close to the first frame member 12 and a second compression member 20 may be disposed within the third frame member 50 close to the second frame member 14. In the illustrated embodiment, the compression members 20 each include a threaded shaft 22 (shown in phantom) that threadedly engage a corresponding threaded aperture 24 that is formed within the holder 10. The compression members 20 each include a knob 26 that can be used to rotate the compression members 20 in a desired direction to either raise or lower the compression members 20.

The holder 10 includes a window 28 that extends front to back (in the illustrated orientation) between the first frame member 12 and the second frame member 14. Once a number of polymeric fibers 30 have been disposed within the holder 10, the polymeric fibers 30 will extend across the window 28 such that the polymeric fibers 30 may be exposed to a desired light source for testing.

The holder 10 may be configured for use in any desired optical testing apparatus. In some embodiments, the holder 10 may be used in combination with an integrating sphere and a suitable detector such as a spectrophotometer. An integrating sphere, sometimes referred to as an Ulbricht sphere, is an optical component that includes a hollow cavity. An interior surface of the hollow cavity is coated for high diffuse reflectivity and has relatively small entrance and exit ports. Light entering the integrating sphere undergoes multiple scattering reflections and is distributed equally to all points within the sphere. The integrating sphere may, therefore, be thought of as preserving power but eliminating spatial information.

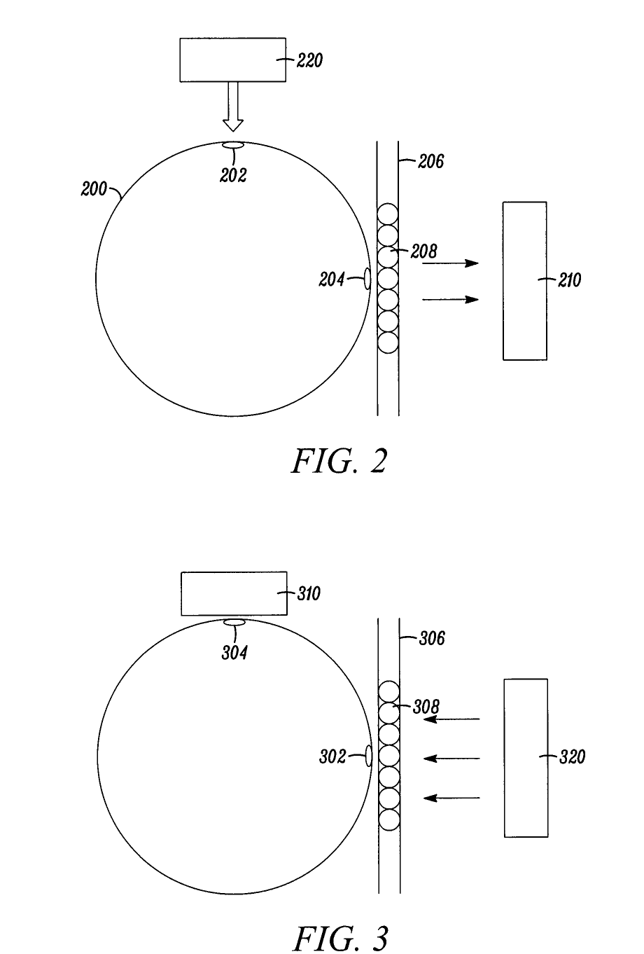

FIGS. 2 and 3 are schematic illustrations of suitable testing configurations. In FIG. 2, an integrating sphere 200 is arranged such that light from a light source 220 enters an entrance port or window 202 and is uniformly scattered within the integrating sphere 200. The integrating sphere 200 has an exit port or window 204. A holder 206 bearing polymeric fibers 208, such as the holder 10 described with respect to FIG. 1, is arranged adjacent the exit port 204. A detector 210 is positioned such that light exiting the exit port 204 passes through the polymeric fibers 208 and strikes the detector 210. The detector 210 may be any suitable optical detector and may be sensitive to any desired wavelength of light. In some embodiments, the detector 210 is sensitive to light having average wavelengths in the range of about 450 nanometers to about 550 nanometers.

As will be appreciated, a comparison of light entering the integrating sphere 200 and the light striking the detector 210 may provide an indication of the optical property being tested. In some embodiments, this comparison will yield information regarding the transparency of the polymeric fibers 208, such as light transmittance.

In FIG. 3, an integrating sphere 300 is arranged such that light from a light source passes 320 through a holder 306 bearing polymeric fibers 308. The light passing through the polymeric fibers 308 passes through an entrance port or window 302 of an integrating sphere 300. The light exits the integrating sphere 300 through an exit port or window 304 and strikes a detector 310 that is disposed adjacent the exit port 304. The detector 310 may be any suitable optical detector and may be sensitive to any desired wavelength of light. In some embodiments, the detector 310 is sensitive to light having average wavelengths in the range of about 450 nanometers to about 550 nanometers.

A comparison of light leaving the light source 320 and the light striking the detector 310 may provide an indication of the optical property being tested. In some embodiments, this comparison will yield information regarding the transparency of the polymeric fibers 308, such as light transmittance.

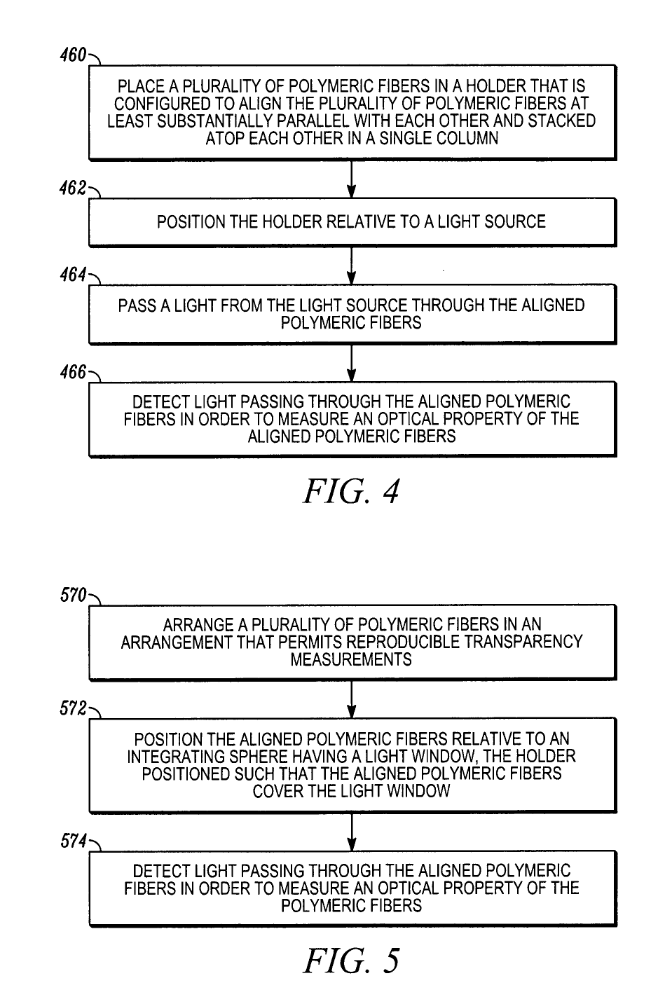

FIG. 4 is a flow diagram illustrating a method that may be carried out in accordance with an embodiment of the present invention. A plurality of polymeric fibers may be placed in a holder (such as the holder 10) that is configured to align the plurality of polymeric fibers at least substantially parallel with each other and stacked atop each other in a single column as generally indicated at block 460. As shown at block 462, the holder may be positioned relative to a light source (such as the light source 220 or 320). Light from the light source may pass through the aligned polymeric fibers as generally indicated at block 464. As shown at block 466, the light passing through the aligned polymeric fibers may be detected (using a detector such as the detector 210 or 310) in order to measure an optical property of the aligned polymeric fibers.

FIG. 5 is a flow diagram illustrating a method that may be carried out in accordance with an embodiment of the present invention. A plurality of polymeric fibers may be arranged in an arrangement that permits reproducible transparency measurements, as generally indicated at block 570. As shown at block 572, the aligned polymeric fibers may be positioned relative to an integrating sphere having a light window, the holder positioned such that the aligned polymeric fibers cover the light window. Light passing through the aligned polymeric fibers may be detected using any suitable detector in order to measure an optical property of the polymeric fibers, as referenced at block 574.

### EXAMPLES

The present invention is more particularly described in the following examples that are intended as illustrations only, since numerous modifications and variations within the scope of the present invention will be apparent to those skilled in the art.

### Example 1

In Example 1, polyamide fiber samples having different polymer compositions were tested to ascertain differences resulting from testing at different wavelengths using testing machines utilizing integrating spheres. The machines used for testing were a COLORQUEST XE using wavelengths of about 550 nanometers and a Varian Cary 4000 UV-Vis Spectrometer using wavelengths of about 550 nanometers.

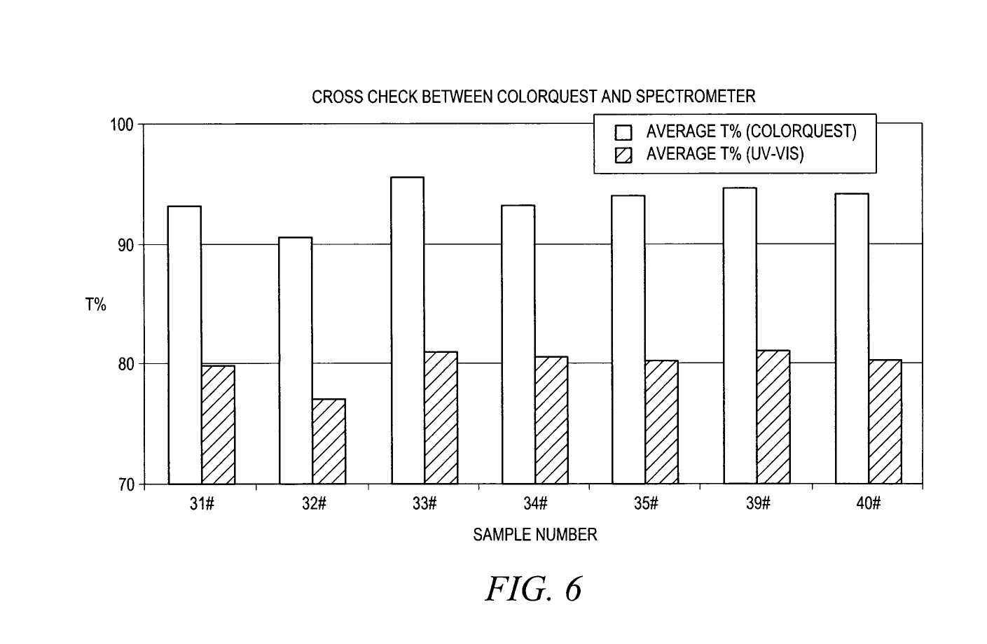

FIG. 6 is a graphical representation of the average transmittance data recorded for all of the fiber samples tested, using both machines. While the actual transmittance data recorded is machine dependent (as evidenced by the COLORQUEST XE providing generally higher transmittance values than the Varian Cary 4000 UV-Vis spectrometer), it can be seen that the average transmittance values for the samples allows for differentiation of the relative transmission of samples.

### Example 2

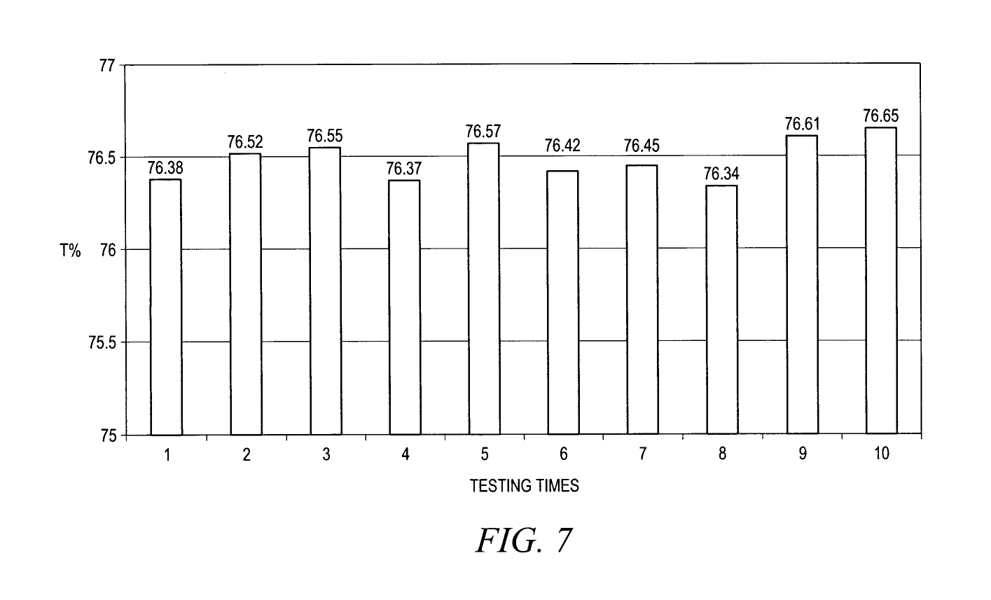

In Example 2, polyamide fiber samples formed from the same polyamide composition were tested to ascertain reproducibility. The fibers were tested with a Varian Cary 4000 UV-Vis Spectrometer using wavelengths of about 550 nanometers. As seen in FIG. 7, the same fibers were tested a number of times and provided consistent values for transmittance, indicating a good degree of test reproducibility.

### Example 3

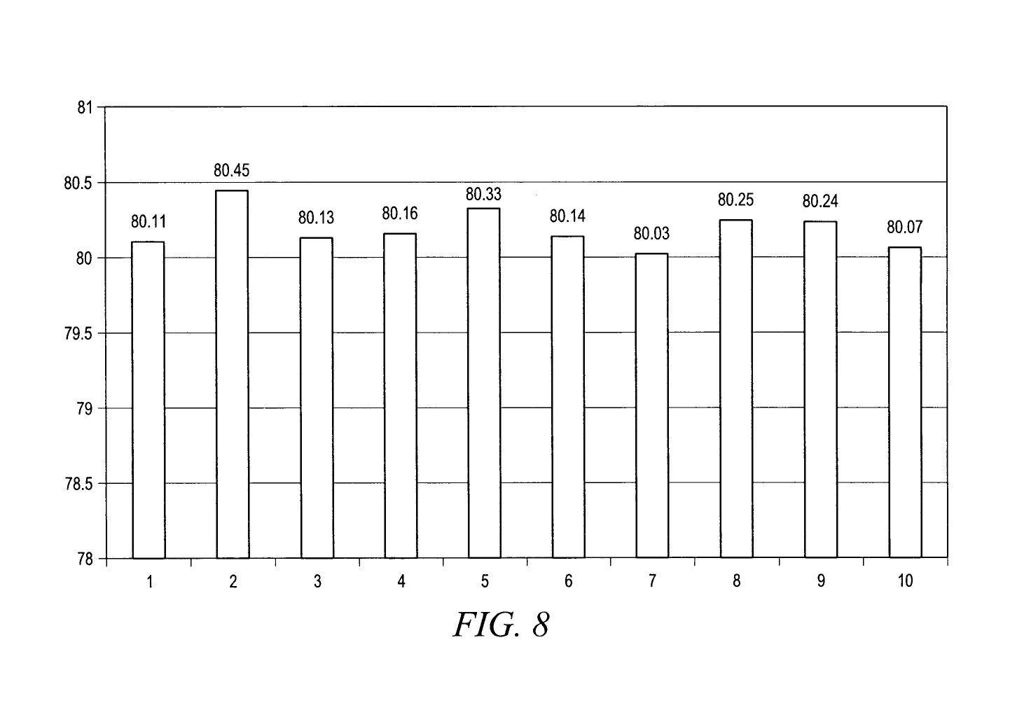

In Example 3, polyamide fiber samples formed from the same polyamide composition were tested to ascertain reproducibility. The fibers were tested using the Varian Cary 4000 UV-Vis Spectrometer using wavelengths of about 550 nanometers. As seen in FIG. 8, the same fibers were tested a number of times and provided consistent values for transmittance, indicating a good degree of test reproducibility.

From the foregoing description, one skilled in the art can easily ascertain the essential characteristics of this invention and, without departing from the spirit and scope thereof, can make various changes and modifications of the invention to adapt it to various usages and conditions.

We claim:

1. A method of measuring an optical property of polymeric fibers, the method comprising:
placing a plurality of polymeric fibers in a holder that is configured to align the plurality of polymeric fibers at least substantially parallel with each other and stacked in a single column;
positioning the holder relative to a light source;
passing a light from the light source through the aligned polymeric fibers; and
detecting light passing through the aligned polymeric fibers in order to measure an optical property of the aligned polymeric fibers.

2. The method of claim 1, further comprising, subsequent to placing a plurality of polymeric fibers in a holder, applying a force to the plurality of polymeric fibers in order to hold the plurality of polymeric fibers closely together.

3. The method of claim 1, wherein positioning the holder relative to a light source comprises positioning the holder relative to an integrating sphere having a light window, the holder being positioned such that the aligned fibers cover the light window.

4. The method of claim 3, wherein detecting light passing through the aligned polymeric fibers comprises detecting light exiting the integrating sphere through the light window and passing through the aligned polymeric fibers.

5. The method of claim 3, wherein detecting light passing through the aligned polymeric fibers comprises detecting light passing through the aligned polymeric fibers and entering the integrating sphere through the light window.

6. The method of claim 1, wherein the optical property comprises light transmittance.

7. A method of measuring transparency of polymeric fibers, the method comprising:
arranging a plurality of polymeric fibers in an arrangement that permits reproducible transparency measurements;
positioning the aligned polymeric fibers relative to an integrating sphere having a light window, the holder positioned such that the aligned polymeric fibers cover the light window; and
detecting light passing through the aligned polymeric fibers in order to measure light transmittance through the polymeric fibers.

8. The method of claim 7, wherein arranging a plurality of polymeric fibers in an arrangement that permits reproducible transparency measurements comprises placing the plurality of polymeric fibers in a holder that is configured to align the plurality of polymeric fibers at least substantially parallel with each other.

9. The method of claim 7, further comprising, subsequent to placing the plurality of polymeric fibers in a holder, applying a force to the plurality of polymeric fibers in order to hold the plurality of polymeric fibers closely together.

10. The method of claim 7, wherein detecting light passing through the aligned polymeric fibers comprises detecting light exiting the integrating sphere through the light window and passing through the aligned polymeric fibers.

11. The method of claim 7, wherein detecting light passing through the aligned polymeric fibers comprises detecting light passing through the aligned polymeric fibers and entering the integrating sphere through the light window.

12. A holder for testing optical properties of polymeric fibers, the holder comprising:
a first frame member;
a second frame member spaced apart from the first frame member to define a window between the first frame member and the second frame member;
a channel extending through the holder, the channel configured to accommodate polymeric fibers extending across the window;
an enlarged opening extending through the holder and in communication with the channel; and
a compression bar configured to be inserted into the enlarged opening and provide a compressive force on polymeric fibers disposed within the channel.

13. The holder of claim 11, wherein the channel is configured to align polymeric fibers stacked in a single column.

14. The holder of claim 13, wherein the channel has a minor dimension that is slightly larger than a diameter of the polymeric fibers.

15. The holder of claim 14, wherein the channel has a minor dimension that is about 0.01 millimeters to about 0.05 millimeters greater than a diameter of the polymeric fibers.

16. The holder of claim 13, wherein the enlarged opening is configured to permit the compression bar to be inserted through the holder and moved into contact with polymeric fibers disposed within the channel.

17. The holder of claim 13, wherein the compression bar comprises a first portion that is configured to fit within the enlarged portion and a second portion that is configured to fit within the channel.

18. The holder of claim 17, wherein a mass of the compression bar provides a compressive force on polymeric fibers disposed within the channel.

19. The holder of claim 12, further comprising:
a third frame member spanning between the first frame member and the second frame member;
a first compression member disposed within the third frame member; and
a second compression member disposed within the third frame member, the first and second compression members configured to releasably provide a compressive force to the compression bar.

20. The holder of claim 19, wherein the first compression member and the second compression member are threadedly engaged with the third frame member.
